(19) United States
(12) Patent Application Publication
(10) Pub. No.: US 2014/0231043 A1
(43) Pub. Date: Aug. 21, 2014

(54) Device for Cooling Glassware

(71) Applicant: Nicolous Austin Reimers, Port Hueneme, CA (US)

(72) Inventor: Nicolous Austin Reimers, Port Hueneme, CA (US)

(21) Appl. No.: 14/159,018

(22) Filed: Jan. 20, 2014

Related U.S. Application Data
(60) Provisional application No. 61/755,633, filed on Jan. 23, 2013.

(51) Int. Cl. A47J 47/16

(52) U.S. Cl. CPC A47J 47/16
USPC 165/47; 454/338

(57) ABSTRACT

A device for cooling glassware is described herein. The device can be arranged with existing glass containers and can efficiently cool heated glassware to room temperature, reducing instances of thermal shock and resulting microfractures. The device comprises a body 102, a cooling element 104, a power supply 106, and a control element 108. The device is particularly useful in the context of restaurant and food services operation and increases productivity and safety while reducing space requirements and inventory costs.

### BACKGROUND OF THE INVENTION

1. Field of the Invention

The present invention relates generally to a device for the cooling of glassware and like materials, and particularly for the cooling of glass kitchen and dining utensils.

2. Description of the Related Art

Glassware is utilized in many different fields and environments including laboratories, manufacturing plants, art studios and restaurants. While useful and effective for its intended purposes, glassware is susceptible to thermal shock, which occurs when a thermal gradient causes different parts of the glassware to expand by different amounts, potentially resulting in the formation of microfractures in the glassware which. undermine its structural integrity.

The danger of thermal shock is particularly evident in the fast-paced field of restaurant operation, where glassware is commonly exposed to high temperatures and placed into direct contact with employees and customers. Glassware, such as drinking glasses, is typically cleaned and sanitized by placing it into holding containers such as glass-racks, and then placing the glass-racks into a standard dishwasher. Standard food-services glass-racks are generally rectangular and comprise various slots for holding drinking glasses in place. The glassware is then heated within the dishwasher to high temperatures sufficient to sanitize the glassware in compliance with various health and safety standards. The glass-rack is then removed from the dishwasher, and the glassware is left in the glass-rack to cool to room temperature from exposure to the ambient air. Typically, The glass-racks are stacked on one another for the duration of the cooling process to conserve space. This process takes a significant amount of time and cannot always keep up with the customer demand for glassware. Thus, the restaurant is required to either keep an inordinate supply of glassware on hand or find another means of cooling the glassware.

One such commonly utilized means to hasten the glassware cooling process is by holding the hot glassware under cold water. Alternatively, some servers may not allow the glassware to completely reach room temperature before placing cold liquid drinks and ice into the still warm glassware. Both of these methods increase the thermal shock chat the glassware is exposed to and can cause microfractures. Such damaged glassware has a shorter useable lifespan and can potentially break, or in rarer cases explode, in human hands. This results in several concerns or the restaurant management including safety hazards, potential litigation and lost inventory.

What is needed is an efficient device that can rapidly cool glassware while avoiding or mitigating the formation of microfractures due to thermal shock.

### SUMMARY OF THE INVENTION

Described herein is a device for efficiently cooling glassware. The device comprises a body, a cooling element, a power supply, and a control element. The body of the device is configured to align or interact with containers that can contain glassware, for example, standard sized industrial restaurant glass racks for holding drinking glasses.

These and other further features and advantages of the invention would be apparent to those skilled in the art from the following detailed description, taking together with the accompanying drawings, in which:

### BRIEF DESCRIPTION OF THE DRAWINGS

FIG. 1 is a front view of an embodiment of a cooling device according to the present invention;

FIG. 2 is a front perspective view of an embodiment of a cooling device according to the present invention;

FIG. 3 is a back perspective view of an embodiment of a cooling device according to the present invention;

FIG. 4 is a top perspective view of an embodiment of a cooling device according to the present invention; and

FIG. 5 is a side perspective view of an embodiment of a cooling device according to the present disclosure.

### DETAILED DESCRIPTION OF THE INVENTION

The present disclosure is directed to embodiments of cooling devices that align or interact with containers that can contain glassware. Devices according to the present disclosure can efficiently cool heated glassware to room temperature, mitigating the amount of thermal shock to which the glassware is exposed. This results in lower costs, savings of time, lower necessary inventory, extended glassware useable lifespan and reduction of necessary space occupied.

Throughout this description, the preferred embodiment and examples illustrated should be considered as exemplars, rather than as limitations on the present invention. As used herein, the term “invention,” “device,” “present invention” or “present device” refers to any one of the embodiments of the invention described herein, and any equivalents. Furthermore, reference to various feature(s) of the “invention,” “device,” “present invention” or “present device” throughout this document does not mean that all claimed embodiments or methods must include the referenced feature (s).

It is also understood that when an element or feature is referred. to as being “on” or “adjacent” another element or feature, it can be directly on or adjacent the other element or feature or intervening elements or features may also be present. Furthermore, relative terms such as “outer”, “above”, “lower”, “below”, and similar terms, may be used herein to describe a relationship of one feature to another. It is understood that these terms are intended to encompass different orientations in addition to the orientation depicted in the figures.

Although the terms first, second, etc. may be used herein to describe various elements or components, these elements or components should not be limited by these terms. These terms are only used to distinguish one element or component from another element or component. Thus, a first element or component discussed below could be termed a second element or component without departing from the teachings of the present invention. As used herein, the term “and/or” includes any and all combinations of one or more of the associated list items.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes” and/or “including when used herein, specify the presence of stated features, integers, steps, operations, elements, and/or components, but do not preclude the presence or addition of one or more other features, integers, steps, operations, elements, components, and/or groups thereof.

Although the terms “glass” and “glassware” are used, it is understood the devices according to the present disclosure can be used to cool other materials as well, including but not limited to ceramic materials that can be susceptible to microfractures caused by thermal shock.

Although the present disclosure mentions use of airflow and convection cooling means and evaporation cooling means, it is understood that other cooling means can be used in conjunction with the disclosed embodiments and that the present disclosure is not limited to such cooling means.

Embodiments of the invention are described herein with reference to different views and illustrations that are schematic illustrations of idealized embodiments of the invention. As such, variations from the shapes of the illustrations as a result, for example, of manufacturing techniques and/or tolerances are expected. Embodiments of the invention should. not be construed as limited to the particular shapes of the regions illustrated herein but are to include deviations in shapes that result, for example, from manufacturing.

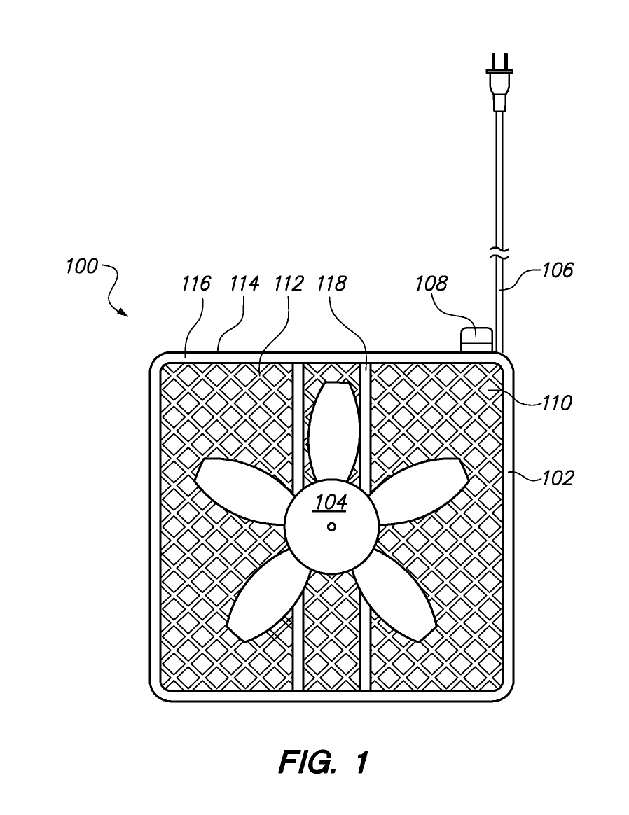

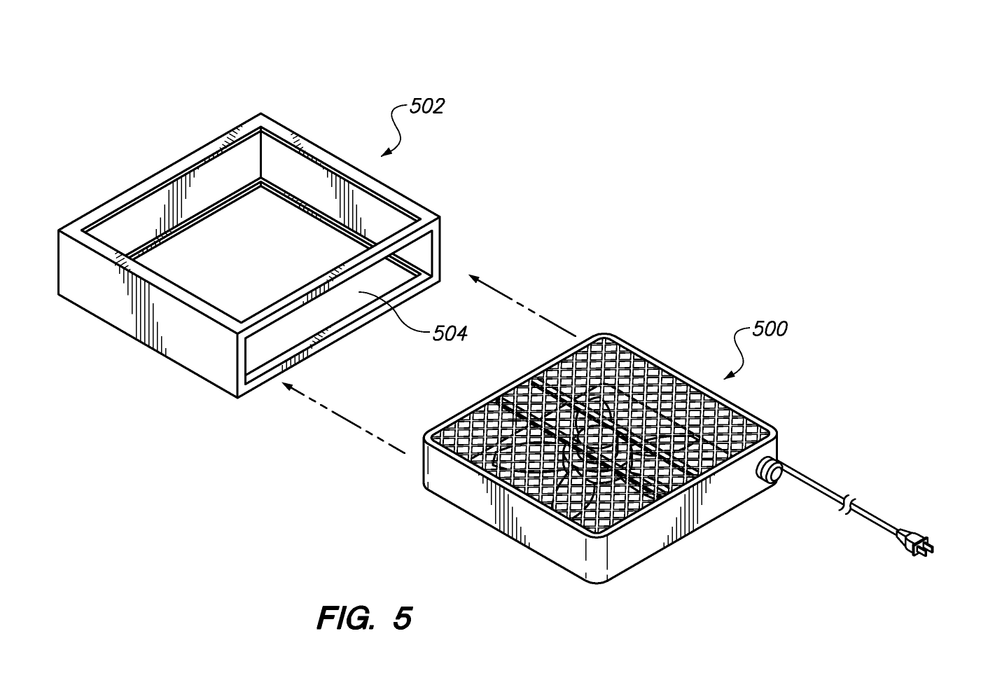

FIG. 1 is a front view of an embodiment of a cooling device 100 according to the present invention. Cooling device 100 comprises a body 102, a cooling element 104, a power supply 106, and a control element 108. Body 102 can comprise any number of shapes, with the preferred shape being a shape that can facilitate the alignment or interaction of body 102 with containers for holding glassware, for example glass-racks. In one embodiment, the body is a cube with dimensions as follows: length 19 and ½ inches, width 19 and ½ inches, and height 4 inches (when body 102 is oriented as shown in FIG. 5). in this embodiment, body 102 is sized to align with the majority of commercial restaurant glass-racks and can be easily arranged in a stack with one or more glassware-containing glass-racks such that body 102 is the topmost or bottommost member of the stack. When cooling device 100 is arranged as the bottommost member of such a stack, the exposed open, or gridded, top portion of body 102 faces the stack upward. When cooling device 100 is arranged as the topmost member of such a stack, the exposed open top portion of body 102 faces the stack downward.

While it is understood that there can be arrangements according to the present disclosure which encompass cooling devices configured to be placed on the side of a stacked plurality of glass-racks, or arranged in a variety of different ways, one advantage of arranging body 102 as the topmost or bottommost member of a stack of glassware-containing glass-racks is that it allows for uniform cooling of glassware while conserving floor space.

Body 102 can comprise many different materials. In one embodiment, body 102 comprises a waterproof or water-resistant material. In another embodiment, body 102 comprises plastic. In yet another embodiment, body 102 comprises metal. In embodiments wherein cooling device 100 is to be arranged as the bottommost member of a stack of glass-racks, body 102 should be made of a material that could support the weight of a sufficiently large stack.

Body 102 can further comprise one or more holes 110, which can facilitate the movement of air throughout the device. Holes 110 can be formed on the bottom portion 112 and/or side portions 114 of body 102. In one embodiment, holes 110 are formed in bottom portion 112, and bottom portion 112 is configured such that a significant portion of bottom portion 112 is not in direct contact with the ground. This can be accomplished by various means including but not limited to making the lower outer perimeter of bottom portion 112 have a greater height than the rest of bottom portion 112 (this will be discussed in more detail further below) or by installing raised support structures, such as pegs (not shown) which elevate bottom portion 112 off the ground. In these embodiments, cooling device 100 can be arranged as the bottommost portion of a stacked plurality of glass-racks and holes 110 in bottom portion 112 are not covered by the ground, resulting in more air being drawn in or expelled from the device.

Body 102 can comprise an upper outer perimeter 116. Upper outer perimeter 116 can comprise a variety of features that can facilitate attachment of glassware-containing glass-racks to body 102. In one embodiment, upper outer perimeter 116 comprises holes or tabs which can interact with holes or tabs on a standard glass-rack. Standard glass-racks typically have holes or tabs arranged such that they can be securely stacked upon one another. Upper outer perimeter 116 can be configured with holes or tabs that can interact with the holes and tabs found in standard glass-racks. Upper outer perimeter 116 can also comprise a lip portion providing a base with a raised outer perimeter allowing the bottom portion of glassware-containing glass-racks to rest on the base portion and be surrounded by the raised outer perimeter. This lip structure would also provide more stability in embodiments wherein cooling device 100 is arranged as the topmost member of a stack of glass-racks. One advantage of this lip structure is that cooling device 100 can be more freely utilized with glass-racks having dimensions smaller than body 102.

Although body 102 is depicted in FIG. 1 as having a completely open top portion, it is understood that various other top portions can be used. For example, in one embodiment, a top portion can comprise a partially open portion surrounded by a closed portion with a tapered diameter, creating a funnel-like structure in relation no cooling element 104, or gridded to protect a user. In embodiments including upper outer perimeter 116, wherein upper outer perimeter 116 comprises a lip structure, the base portion of the lip structure can extend and form a closed top portion with an open section to allow air from cooling element 104 to flow through the closed top portion. It is understood that various other arrangements of a top portion to alter the direction of airflow from cooling element 104 or no facilitate attachment or arrangement of cooling element 100 with a glass-rack can be utilized with devices according to the present disclosure.

Cooling element 104 provides a means of cooling glassware held in containers such as glass-racks, which are arranged with cooling device 100. Cooling element 104 can comprise a wide variety of cooling elements including but not limited to a mechanical fan (including but not limited to an axial-flow fan, a centrifugal fan, and a cross flow fan), an evaporative cooler, a vacuum device, a cooling coil, and/or multiples and combinations thereof. Cooling element 104 in the embodiment depicted in FIG. 1 is a standard mechanical axial-flow fan comprising blades that force air to move parallel to the shaft about which the blades rotate. The flow of air is thus directed in a direction toward and roughly perpendicular to the open top surface of body 102.

When cooling device 100 is arranged as the topmost member in a stack of one or more glass-racks, air is directed toward the glass-racks in a downward manner. When cooling device 100 is arranged as the bottommost member in a stack of one or more glass-racks, air is directed toward the glass-racks in a upward manner. This allows for steady, simultaneous and uniform cooling of multiple pieces of glassware via convection. This allows for glassware that has been heated, for example, by a dishwasher, to more quickly reach room temperature without being exposed to a substantial temperature gradient and/or having different portions of a piece of glassware being exposed to significantly different temperatures. This reduces thermal shock and subsequent formation of microfractures.

Cooling element 104 can be secured in place by one or more attachment elements 118 (two shown). In one embodiment, attachment elements 118 are rail bars that attach to body 102 and cooling element 104. Cooling element 104 can be attached to body 102 or attachment element 118 via a movable structure such as a hinge. Such a moveable structure allows cooling element 104 to be adjusted to further control direction of airflow through the device. It is understood that cooling element 104 can be attached. to or built into body 104 in a variety of ways including but not limited to being held in place via an adhesive such as cement, being bolted to body 102 and being held in place by an attachment element.

Cooling device 100 further comprises power supply 106. Power supply 106 provides electrical power to cooling element 104. Various power supplies can be used including but not limited to batteries and/or battery packs (rechargeable or disposable), solar cells and/or cords attached to cooling element 104 and arranged to plug into a standard wall outlet. In embodiments utilizing a power cord, portions of body 102 and/or attachment elements 118 can be made hollow or otherwise arranged to conceal the presence of the cord within cooling device 100 for aesthetic purposes.

Cooling device 100 further comprises control element 108. Control element 108 can comprise a wide variety of different mechanisms. Control element 108 can be a switch configured to turn cooling device 100 on or off by interrupting or altering the flow of electricity to cooling element 104. In the embodiment shown in FIG. 1, control element 108 comprises a dial switch that can be moved into different positions to change the flow of electricity to cooling element 104, altering the speed and rate of cooling produced by cooling element 104. Control element 108 can be a computer or device utilizing a pre-programmed algorithm set to alter on/off state and/or the rate of cooling of the device based on predetermined factors or sequences of events. Control element 103 can comprise a timing device to regulate the on/off state and/or the rate of cooling of the device according to the passage of time. Control element 103 can be controlled via a remote controlled device. Control element 108 can be a pressure sensitive element that will act as a switch when a pre-determined amount of weight is stacked on cooling device 100. It is understood that many different control elements can be utilized with cooling device 100.

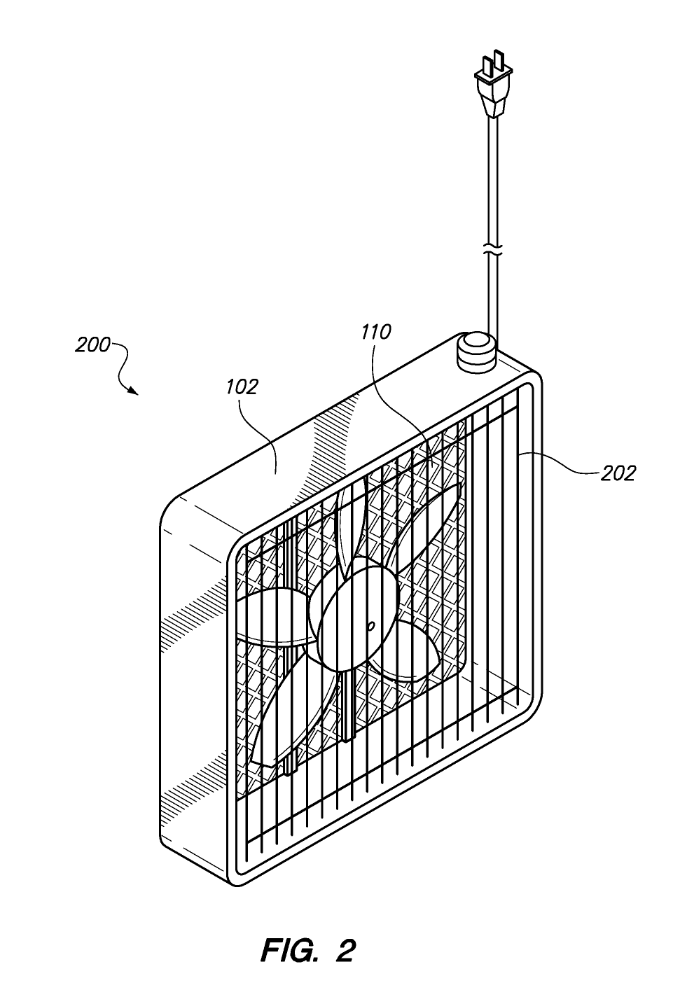

FIG. 2 depicts a cooling device 200, similar to cooling device 100, wherein the corresponding disclosure above is incorporated into this embodiment such that like features share the same reference numbers. Cooling device 200 further comprises filter element 202. Filter element 202 can comprise many different filters. In the embodiment shown in FIG. 2, filter element 202 comprises a screen. Filter element 202 can be arranged over the open top portion of cooling device 200 (as shown) and/or arranged over the back and side portions of body 102 to cover holes 110. An advantage of embodiments utilizing filter element 202 is that surrounding debris such as lint and dust can be prevented from being drawn into cooling device 200 and being sent toward glassware in adjacent glass-racks where such material can contaminate the glassware. This is particularly important in applications of devices according to the present disclosure involving dining glassware in restaurants, as contaminating glassware with surrounding debris can potentially violate state and federal health codes.

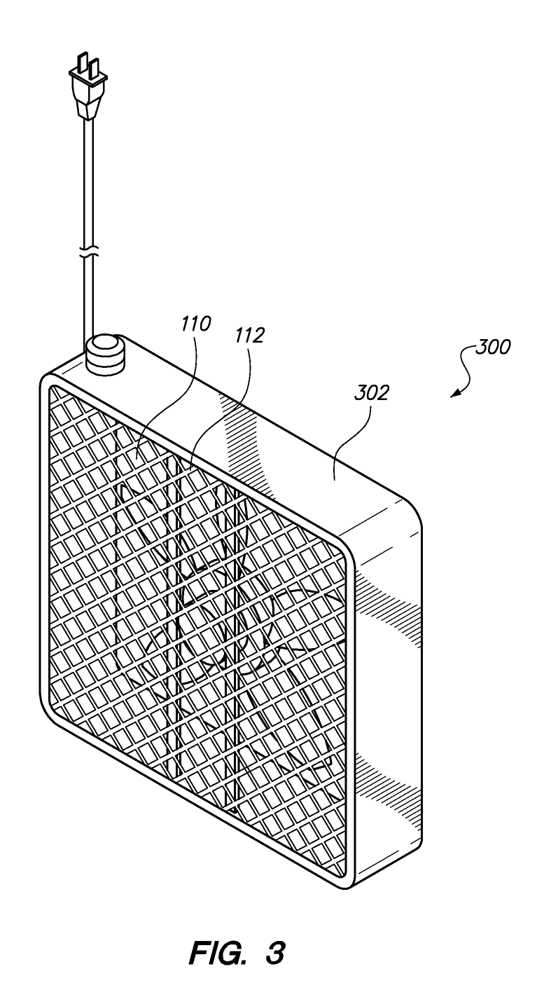

FIG. 3 depicts a cooling device 300, similar to cooling device 100, wherein the corresponding disclosure above is incorporated into this embodiment such that like features share the same reference numbers. FIG. 3 is a back perspective view and more clearly shows embodiments in which lower outer perimeter 302 of bottom portion 112 has a greater height than the rest of bottom portion 112. This elevates bottom portion 112 such that holes 110 are not covered by the ground. A similar structure can be formed on the top portion of cooling device 300, thus resulting in an embodiment wherein the upper outer perimeter comprises a lip structure as discussed above.

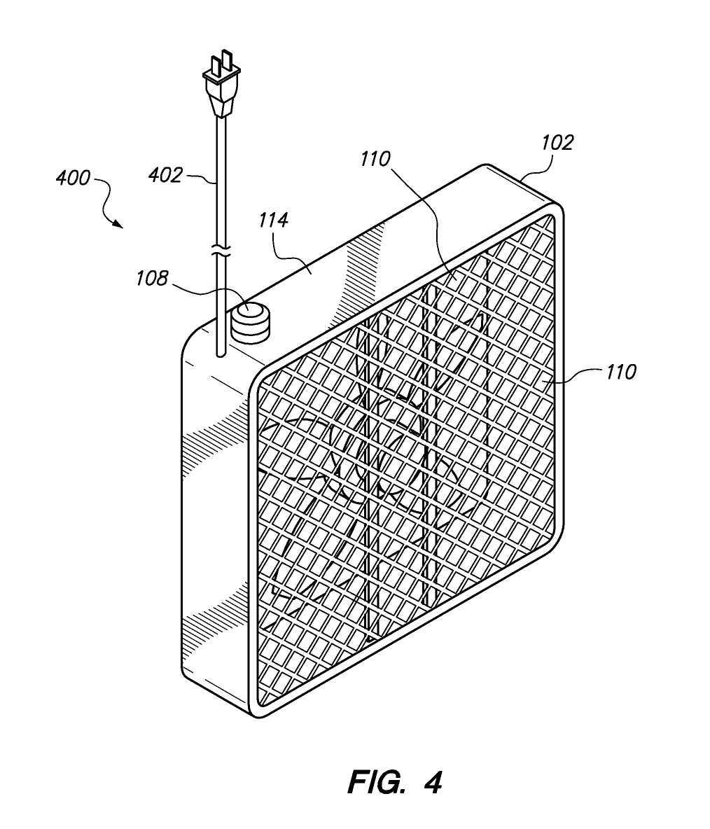

FIG. 4 depicts a cooling device 400, similar to cooling device 100, wherein the corresponding disclosure above is incorporated into this embodiment such that like features share the same reference numbers. FIG. 4 is a top perspective view and more clearly shows side portions 114 comprising holes 110. FIG. 4 also shows control element 108 attached no body 102 via external connection element 402. Such external connection elements include but are not limited to twist-tie devices, clips, clamps and cable ties. Such external connections can also be used to secure adjacent glass-racks to cooling device 400, for example by attaching to grooves formed into body 102 and/or by attaching to holes 110.

FIG. 5 depicts a cooling device 500, similar to cooling device 100, wherein the corresponding disclosure above is incorporated into this embodiment such that like features share the same reference numbers. Cooling device 500 further comprises support unit 502. Support unit 502 has one or more openings 504 in which cooling device 500 can be placed by, for example, sliding cooling device 500 into opening 504. Support unit 502 can be arranged in a stacked. formation with glass-racks in a manner similar to cooling device 100 above, and can comprise similar features that enable or enhance alignment, and/or attachment to the glass-racks.

An advantage of using support unit 502 is that multiple support units can be arranged such that multiple stacks of glass-racks can each have one corresponding support unit. This allows a single cooling device to be able to service multiple glass-racks in sequence more rapidly. For example, rather than having to remove each one of the cooled glassware-containing glass-racks in a stack and re-stacking heated glassware-containing glass-racks on cooling device 500, one can stack heated glassware-containing glass-racks in multiple stacks wherein each stack contains one support unit, and conveniently move cooling device 500 into another support unit when the current stack has finished cooling.

Support unit 502 and/or cooling device 500 can be further arranged in various ways. For example, either can be permanently or temporarily installed into or attached to an easily transportable medium. such as a dolly cart. Likewise, support unit 502 and/or cooling device 500 can be installed directly into a section of the floor. It is understood that many other arrangements that still allow the devices to align, attach or interact with corresponding glass-racks can be utilized with devices according to the present disclosure.

One advantage of devices according to the present. disclosure is that the devices can simultaneously cool and dry glassware. A glassware-containing glass-rack can be directly removed from a dishwasher and placed in a stack with a cooling device. The glassware can be cooled via convection, which will also encourage the evaporation of water droplets on the glassware, also further cooling the glassware via evaporation. Evaporation is efficient enough that little to no water is left on the ground after the glassware is cooled and dried. However, it is understood that devices according to the present disclosure can further comprise features that collect or encourage the direction of water-flow to further prevent the formation of water puddles on the floor. Such features include but are not limited to louvered sidewalls that would encourage water to remain within the device and a water collection well, tray or pan.

Although the present invention has been described in detail with reference to certain preferred configurations thereof, other versions are possible. Embodiments of the present invention can comprise any combination of compatible features shown in the various figures, and these embodiments should not be limited to those expressly illustrated and discussed. Therefore, the spirit and scope of the invention should not be limited to the versions described above.

The foregoing is intended to cover all modifications and alternative constructions falling within the spirit and scope of the invention as expressed in the appended claims, wherein no portion of the disclosure is intended, expressly or implicitly, to be dedicated to the public domain if not set forth in the claims.

1. A device for cooling glassware, comprising:
a body, said body configured to align with at least one container configured to hold items comprising glass or other ceramic material;
a cooling element configured to cool said items;
a power supply to provide power to said cooling element, and
a control element for controlling operation of said device.

2. The device of claim 1, wherein said container is a glass-rack.

3. The device of claim 1, wherein said cooling element is configured to direct air to cool said glassware by convection.

4. The device of claim 3, wherein said cooling element comprises a fan.

5. The device of claim 1, wherein said body comprises a water-resistant material.

6. The device of claim 1, wherein said body comprises one or more holes to facilitate the movement of air throughout said device.

7. The device of claim 1, wherein said body comprises a bottom portion, said bottom portion configured such that a significant portion of said bottom portion is not in direct contact with the ground when said device is placed on a flat surface with said bottom portion facing said flat surface.

8. The device of claim 1, wherein said body comprises an upper outer perimeter configured to facilitate alignment of said body to said at least one container.

9. The device of claim 8, wherein said upper outer perimeter further comprises a lip portion to facilitate alignment of said body to said at least one container in a stacked arrangement.

10. The device of claim 8, wherein said upper outer perimeter is configured to enable attachment of said body to said at least one container in a stacked arrangement.

11. The device of claim 1, further comprising a filter element.

12. The device of claim 1, wherein said control element is configured to alter the speed and rate of cooling provided by cooling element while said device is operational.

13. The device of claim 1, further comprising a support unit configured to accept said cooling device and configured to align with a plurality of containers configured to contain material to be cooled.

14. The device of claim 1, wherein said body is configured to align with said at least one container in a stacked arrangement with said body as the bottommost member in said stacked arrangement and said cooling mechanism directing air in an upward direction toward said at least one container.

15. The device of claim 1, wherein said body is configured to align with said at least one container in a stacked arrangement with said body as the topmost member in said stacked arrangement and said cooling mechanism directing air in a downward direction toward said at least one container.

16. A device for cooling glassware, comprising:
a body, said body having a cube-like shape and comprising an open top portion, at least one side portion and a bottom portion, said body having a length of about nineteen and one-half inches, a width of about nineteen and one-half inches, and a height of about four inches when said body is orientated with said bottom portion facing the ground, said body capable of aligning with at least one container configured to hold items comprising glass or other ceramic material;
a fan configured to direct air toward said open top portion;
a power supply to provide power to said cooling element, and
a control element for controlling operation of said device.

17. The device of claim 16, wherein said body, wherein said body comprises one or more peg structures configured such that said bottom portion is not in direct contact with the ground when said device is placed on a flat surface with said bottom portion facing said flat surface.

18. The device of claim 17, wherein said body comprises a lower outer perimeter having a greater height than said bottom portion, such that said bottom portion is not in direct contact with the ground when said device is placed on a flat surface with said bottom portion facing said flat surface.

19. The device of claim 16, wherein said device is configured with an easily transportable medium.

20. A method for cooling glass or other ceramic material, said method comprising.
placing items comprising glass or other ceramic material into one or more containers, said one or more containers comprising holes allowing airflow to pass into and out of said containers;
aligning a cooling device with said one or more containers in a stacked formation, said cooling device comprising:
a body, configured to align with said one or more containers;
a cooling element configured to direct air toward said one or more containers;
a power supply to provide power to said cooling element, and
a control element for controlling operation of said device; and
powering said cooling device on such that air is directed into said one or more containers, cooling said items.
